(19) United States
(12) Patent Application Publication
(10) Pub. No.: US 2012/0150334 A1
(43) Pub. Date: Jun. 14, 2012

(54) Integrated Fault Detection And Analysis Tool

(75) Inventor: Jeffrey E. Arbogast, Townsend, DE (US)

(73) Assignee: L'Air Liquide Societe Anonyme Pour L'Etude Et L'Exploitation Des Procedes Georges Claude, Paris (FR)

(21) Appl. No.: 12/965,302

(22) Filed: Dec. 10, 2010

(51) Int. Cl. G06F 19/00

(52) U.S. Cl. 700/110

(57) ABSTRACT

As described, a neural network based fault detection and analysis tool may be integrated with a physical (or semi physical) model based fault detection and analysis tool. The physical modeling tool provides a mathematical model of plant processes, e.g., a set of mass/energy balance equations modeling the systems at a specific plant. In contrast, the neural network develops a model of a given set of sensors from process data. One advantage of the neural network based tool is that it does not require fundamental knowledge of the process. However, the neural network is only valid for the conditions for which it was trained (i.e., conditions represented by a set of training data). Therefore, the neural network will occasionally need to be re-trained as the process conditions change. In contrast, the physical modeling tool based tool does not need to be retrained and remains valid for all process conditions accounted for in the fundamental models.

### BACKGROUND

A producer/distributor of purified gases, such as oxygen gas (O₂) and nitrogen (N₂) gas, continuously strives to increase the stability, quality, reliability, safety, and cost-effectiveness of its process plants. At such plants, air separation units (ASUs) are used to distill gases from atmosphere. Similarly, a producer may use a steam reforming furnace to produce hydrogen gas (H₂) from a hydrocarbon feed source. The resulting industrial gases are typically stored in tanks or transported in trucks or over a pipeline to customers for use in other industrial operations.

Running and maintaining this sort of large industrial system is a complicated and expensive process. As a result, sophisticated monitoring and decision support systems have been developed that allow the producer to monitor and control a production facility. For example, software applications are available that monitor the operational state of ASUs, steam hydrocarbon reformers, pipeline components, including compressors and pumps, valves, segments, etc. Sensors affixed to these (and other) devices are configured to relay information regarding a then current state of the device to the control center, where they are stored in a database. In some cases, the monitoring systems may be configured to raise an alarm when a monitored parameter (or combination of parameters) falls below (or climbs above) a predetermined value. In addition to passive sensor devices, plant equipment may include control equipment configured to help maintain an optimal operational state at a plant, as well as shutdown equipment when a malfunction is detected—referred to as a plant trip.

Plant trips are expensive and adversely impact the reliability of a production plant. Sometimes however, plants trips occur due to sensor faults that would not adversely impact plant performance if properly detected and analyzed. That is, a significant percentage of plant trips result not from faulty, malfunctioning, or mis-configured equipment, but due to bad sensor readings or an otherwise malfunctioning sensor. Therefore, there is great potential benefit in distinguishing between sensor faults and actual problems in the monitored systems. That is, there is a great potential benefit in preventing unnecessary plant trips.

Other complex industrial systems and processes use a similar approach. For example, a petroleum refinery (at one end of a pipeline) may be monitored from a central control center configured to receive data collected from the field devices of the refinery.

### SUMMARY

One embodiment of the invention provides a computer-implemented method for sensor fault detection and analysis. The method may generally include receiving a sensor data value for each of one or more sensors, each monitoring an aspect of an industrial process, passing at least some of the sensor data values to at least a physical modeling (PM) tool and a neural network modeling tool. The PM tool and the neural network tool are each configured to determine a predicted value for each passed sensor data value. This method may also include determining, based on the sensor data values and the predicted values determined by the PM tool and the neural network tool, that at least one of the sensors has experienced a sensor fault and replacing the received sensor value for the sensor determined to have experienced the sensor fault with the predicted value determined by one of the PM tool and the neural network tool.

A computer-readable storage medium containing a program, which, when executed on a processor, performs an operation for sensor fault detection and analysis. The operation may generally include receiving a sensor data value for each of one or more sensors, each monitoring an aspect of an industrial process and passing at least some of the sensor data values to at least a physical modeling (PM) tool and a neural network modeling tool. The PM tool and the neural network tool are each configured to determine a predicted value for each passed sensor data value. This operation may further include determining, based on the sensor data values and the predicted values determined by the PM tool and the neural network tool, that at least one of the sensors has experienced a sensor fault and replacing the received sensor value for the sensor determined to have experienced the sensor fault with the predicted value determined by one of the PM tool and the neural network tool.

Still another embodiment includes a system having a processor and a memory storing a monitoring application, which, when executed by the processor, performs an operation for sensor fault detection and analysis. The operation itself may generally include receiving a sensor data value for each of one or more sensors, each monitoring an aspect of an industrial process and passing at least some of the sensor data values to at least a physical modeling (PM) tool and a neural network modeling tool. The PM tool and the neural network tool are each configured to determine a predicted value for each passed sensor data value. This operation may further include determining, based on the sensor data values and the predicted values determined by the PM tool and the neural network tool, that at least one of the sensors has experienced a sensor fault and replacing the received sensor value for the sensor determined to have experienced the sensor fault with the predicted value determined by one of the PM tool and the neural network tool.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers.

FIG. 1 is a conceptual illustration of an industrial production and distribution system managed at an operations control center, according to one embodiment of the invention.

FIG. 2 illustrates a computing system used to provide an integrated fault detection and analysis tool, according to one embodiment of the invention.

FIG. 3 illustrates a method for an integrated fault detection and analysis tool application to identify sensor faults, according to one embodiment of the invention.

FIGS. 4A-4B illustrate an example of industrial sensors monitored using an integrated fault detection and analysis tool application to identify sensor faults, according to one embodiment of the invention.

FIG. 5A-5B are data flow diagrams illustrating different approaches for an integrated fault detection and analysis tool application to identify sensor faults, according to one embodiment of the invention.

### DESCRIPTION OF PREFERRED EMBODIMENTS

Embodiments of the invention provide techniques for sensor fault detection and analysis that help prevent plant trips caused by sensor faults (bad signals). When a sensor fault occurs, the underlying industrial process could be operating normally, but if the control system reacts to incorrect information provided by the sensor, the control system may cause the plant to shut down. As noted, such plant trips can be very expensive, as the plant is unnecessarily shut down until it is determined that the sensor (and not the plant) was the source of the plant trip. Accordingly, embodiments of the invention provide a fault detection and analysis tool that prevents unnecessary plant trips.

In one embodiment, a neural network based fault detection and analysis tool may be integrated with a physical (or semi-physical) model (PM) of a production plant. For example, a first principles modeling (FPM) tool may be used to provide a theoretical model of plant behavior. Similarly, the PM may provide an empirical model based upon a physical understanding that plant operational variables are related, but use an empirical model based upon data gathered through observation. For convenience, embodiments of the invention are described using a (FPM) based fault detection and analysis tool. A FPM based tool provides an a priori mathematical model of plant processes, e.g., a set of mass/energy balance equations modeling the systems at a specific plant. In contrast, the neural network develops a model of a given set of sensors from the process data. One advantage of the neural network based tool is that it does not require fundamental knowledge of the process. However, the neural network is only valid for the conditions for which it was trained (i.e., conditions represented by a set of training data). Therefore, the neural network will occasionally need to be re-trained as the process conditions change. In contrast, the FPM first principles model based tool does not need to be retrained and remains valid for all process conditions accounted for in the fundamental models.

In one embodiment, the FPM based tool may be used to validate a subset of the sensors in a monitored plant; in particular, the group of sensors, for which a mathematical model has been developed. The FPM based tool then generates a predicted value for each modeled sensor. If the sensor value matches the modeled value (within a user specified margin), the sensor value is considered to be validated, i.e., that the sensor has reported an accurate value. Similarly the neural network based tool takes all of the sensor values as inputs and predicts each of their values. However, any validated sensor signals from the first principles model based tool would be in place of the raw sensor signals. Thus, the neural network would make its predictions using the available validated signals combined with raw sensor data. Thus, while only some of the sensors are validated by the FPM based tool, the neural network may receive a value for each sensor, whether accounted for in the FPM model or not. Further, signals from the first principles model based tool may be compared with the predicted values from the neural network based tool. Since these signals have already been validated, any difference (beyond a user-specified margin) between the neural network prediction and the validated signal may be used to identify issues with the neural network. That is, discrepancies between the FPM model predictions and the neural network predictions may indicate that the neural network needs to be retrained. Advantageously, this approach includes attributes of both types of fault detection and analysis tools as well as provides a methodology for addressing one common concern (and key challenge) with neural networks - the need for retraining (particularly the need to identify when retraining is necessary).

Embodiments of the invention are described relative to an integrated fault detection and analysis tool used to monitor ASUs at an industrial gas production facility. However, one of ordinary skill in the art will recognize that the integrated fault detection and analysis tool disclosed herein may be adapted for a variety of purposes, as well as for pipeline components (e.g., pumps used to maintain a liquid pressure within a pipeline) and for other applications. More generally, the operation a broad variety of industrial process equipment may be monitored using the integrated fault detection and analysis tool disclosed herein.

One embodiment of the invention may be implemented as one or more software programs for use with a computer system. The program(s) include instructions for performing embodiments of the invention (including the methods described herein) and may be stored on a variety of computer-readable media. Illustrative computer-readable media include, but are not limited to: (i) non-writable storage media on which information is permanently stored (e.g., read-only memory devices within a computer such as CD-ROM or DVD-ROM disks readable by a CD-ROM or DVD-ROM drive) and/or (ii) writable storage media on which alterable information is stored (e.g., floppy disks within a diskette drive, hard-disk drives, or flash memory devices). Other media include communications media through which information is conveyed to a computer, such as a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

Further, the description herein references embodiments of the invention. However, it should be understood that the invention is not limited to any specifically described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In general, the routines executed to implement the embodiments of the invention, may be part of an operating system or a specific application, component, program, module, object, or sequence of instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

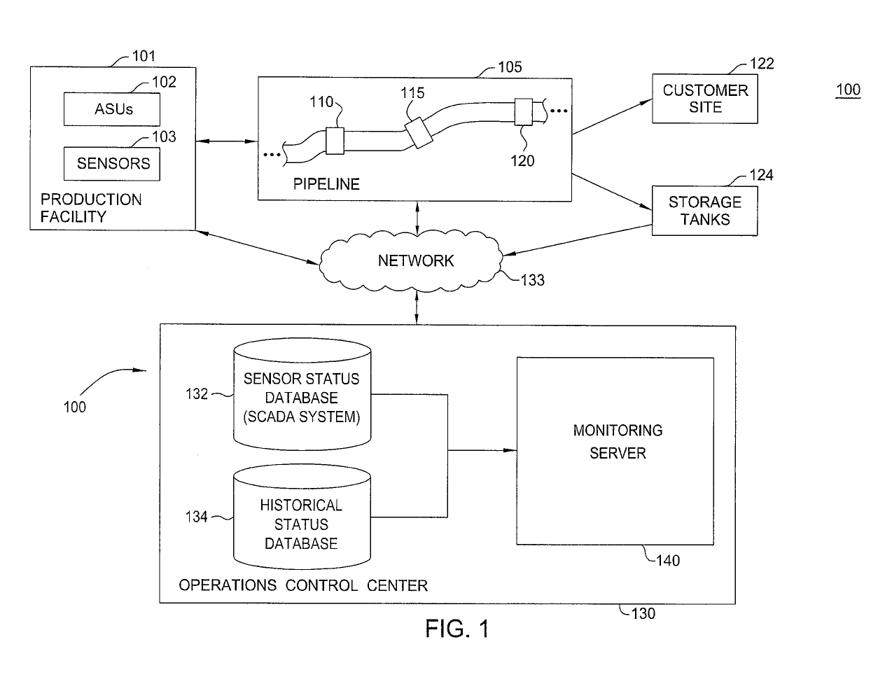

FIG. 1 is a conceptual illustration of an industrial production and distribution system managed 100 at an operations control center 130, according to one embodiment of the invention. As shown, a production facility 101 includes one or more air separation units (ASUs) 102 and sensors 103. The sensors 103 may be configured to monitor a variety of aspects of the ASUs 102. For example, sensors measure input/output product flow rates, temperatures and pressures, compressor motor temperatures, energy consumption.

In this example, product generated by the ASUs may be transported over pipeline network 105. The pipeline network 105 includes three compressor stations 110, 115, and 120. Each of the compressor stations 110, 115, and 120 may include one or more compressors used to maintain the gas pressure present in pipeline 105. Additionally, compressor stations 110, 115, and 120 may include sensor equipment used to monitor aspects of the operational state of pipeline 105. For a pressurized gas pipeline, a wide variety of compressor parameters may be monitored including, for example, inlet gas pressure, outlet gas pressure, gas temperature, cooling liquid temperature, flow rates, and power consumption, among others. Of course, for other applications of the invention, the sensors or monitoring equipment may be selected to suit the needs of a particular case. The monitoring may be dynamic (i.e., “real-time”), or periodic where an operational parameter of the pipeline is sampled (or polled) at periodic intervals. From the pipeline 105, product may be delivered to customer sites 122 or stored in storage tanks 124.

In one embodiment, data obtained by the sensors 103 is transmitted to pipeline operations control center 130 over a network 133. In turn, the operations control center 130 may employ a number of computer systems running application programs used to coordinate, monitor, and control the operations of pipeline 105. Illustratively, the operations control center 130 includes a sensor status database system 132, a historical status database system 134, and a monitoring server system 140. The computer systems 135, 140, and 170 illustrated in operations control center 130 are included to be representative of existing computer systems, e.g., desktop computers, server computers, laptop computers, tablet computers and the like. However, embodiments of the invention are not limited to any particular computing system, application, device, architecture or network, and instead, may be adapted to take advantage of new computing systems and platforms as they become available. Additionally, one skilled in the art will recognize that the illustrations of computer systems 135, 140, and 170 are simplified to highlight aspects of the present invention and that computing systems and networks typically include a variety of components not shown in FIG. 1.

The sensor status database 132 provides a computing system configured with a database application itself configured to receive and store a current value for each sensor in the production facility 101 and the pipeline 105. As new sensor data is received from the production facility 101 and the pipeline 105, data from the sensor status database 132 may be archived in the historical status database 134. In one embodiment, the monitoring server 140 may be configured to monitor the sensor values received from the production facility 101 and the pipeline 105 and identify when a sensor fault has occurred. In such a case, the monitoring server may replace the value from a sensor that has been identified as experiencing a sensor fault with an estimated or predicted value determined using a FPM based modeling tool and/or a neural network modeling tool.

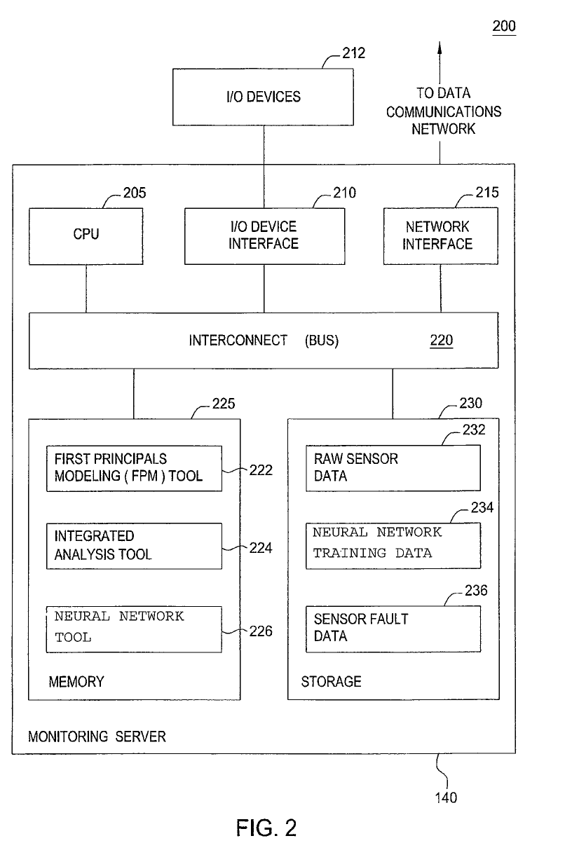

FIG. 2 further illustrates the monitoring server 140 used to provide an integrated fault detection and analysis tool, according to one embodiment of the invention. As shown, the server computing system 140 includes, without limitation, a central processing unit (CPU) 205, a network interface 215, an interconnect 220, a memory 225, and storage 230. The content server 105 may also include an I/O device interface 210 (e.g., keyboard, display and mouse devices).

The CPU 205 retrieves and executes programming instructions stored in the memory 225. Similarly, the CPU 205 stores and retrieves application data residing in the memory 225. The interconnect 220 facilitates transmission, such as of programming instructions and application data, between the CPU 205, I/O devices interface 210, storage 230, network interface 215, and memory 225. CPU 205 is included to be representative of a single CPU, multiple CPUs, a single CPU having multiple processing cores, and the like. And the memory 225 is generally included to be representative of a random access memory. The storage 230 may be a disk drive storage device. Although shown as a single unit, the storage 230 may be a combination of fixed and/or removable storage devices, such as fixed disc drives, solid state devices (SSDs), floppy disc drives, tape drives, removable memory cards, or optical storage, network attached storage (NAS), or a storage area-network (SAN).

Illustratively, the memory 225 includes a first principles modeling (FPM) tool 222, an integrated analysis tool 224, and a neural network tool 226. And storage 230 includes raw sensor data 232, neural network training data 234, and sensor fault data 236. FPM tool 222 provides an application configured to simulate the operations of a specific industrial facility. As noted above, the FPM may model the operations of a set of ASUs. In such a case, the FPM use a set of mass and energy balance equations to model the flows of the specific ASU network at a production facility. Thus, for a given set of inputs, the FPM tool 222 can determine what the value for a given sensor should be. If the raw sensor data 232 for a given senor is different then the value from the FPM modeling tool 222, monitoring system 140 may determine whether an actual malfunction (or other configuration problem) has occurred within an ASU or whether the sensor has experienced a sensor fault. That is, the monitoring system 140 may determine whether the ASU is operating normally and the sensor has malfunctioned or whether the ASU is operating abnormally and the sensor is reporting an accurate (but problematic) sensor value that may result in a plant trip.

For example, consider a first sensor monitoring the flow and temperature at a point in the ASU where two other flows are combined. Assume the two other flows are themselves monitored by a second and third sensor, respectively. If the raw sensor data for the first sensor indicated that the pressure at that sensor has exceed a safe threshold by an amount that should trigger a plant trip, the FPM modeling tool can predict what pressure and/or temperature would need to be present at the second and third sensor point before the value at the first sensor would be observed. If the raw sensor data 232 for the second and third sensors is inconsistent with the predictive values, then the integrated analysis tool 224 may determine that the first sensor has experienced a sensor fault. Such a result may be stored in sensor fault data 236—indicating which sensors are believed to have malfunctioned and are in need of repair or replacement.

Similarly, the neural network tool 226 may be configured to predict the value of one sensor, based on the observed values of other sensors. However, the neural network tool 226 operates by learning through observation rather than being built up from mathematical models. The neural network tool 226 may be trained by presenting it examples sensor measurements. For example, sensor measurements may include the temperature and pressure measurements of the. Training data 234 may include observations of the actual production facility, ASUs, and/or pipeline (i.e., using the raw sensor data 232). Thus, while the FPM tool 222 is able to predict values only the sensors for which it has a specific mathematical model, the neural network tool 226 can be trained to predict the behavior or any sensor or operational scenario using the appropriate set of training data 234.

In one embodiment, the integrated analysis tool 224 provides a software application configured to receive raw sensor data 232 and the predicted values from FPM tool 222 and the neural network tool 225. In the event of a discrepancy between the predicted values and the raw sensor data, the integrated analysis tool 224 may determine whether a sensor is believed to be experiencing a sensor fault. In such a case, the integrated analysis tool 224 may be further configured to replace the raw sensor data 232 for a believed-to-be-malfunctioning sensor with the value from the FPM tool 222 (or neural network 226).

Further still, assume the raw sensor data agrees with the value from the FPM tool 222 (within user specified tolerances). In such a case the raw sensor data is referred to as “validated” data, as the FPM tool has validated that the sensor has reported an accurate value. If the predicted value from the neural network tool 226 disagrees with the validated data value (also within user-specified tolerances), then the integrated analysis tool 224 may use the validated data and other sensor data to retrain the neural network tool 226. That is, if the neural network 226 does not predict a correct value for a functioning sensor, than the neural network may be retrained using that value as another training example of inputs and expected outputs.

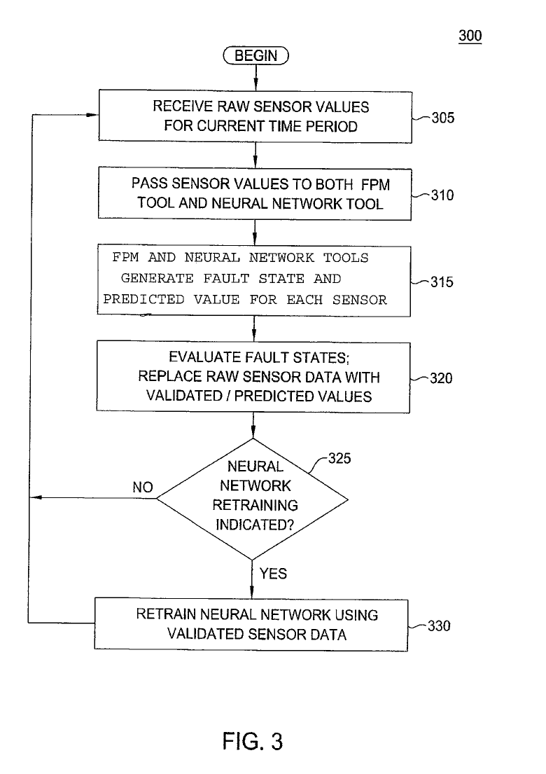

FIG. 3 illustrates a method 300 for an integrated fault detection and analysis tool application to identify sensor faults, according to one embodiment of the invention. As shown, the method 300 begins at step 305 where the integrated analysis tool 224 receives raw sensor data values for a current time period (shown in FIG. 2 as raw sensor data 232). Once received, at step 310, the integrated analysis tool 224 passes the raw sensor data values to both the FPM tool 222 and the neural network tool 226. In response, at step 315, the FPM tool 222 and the neural network tool 226 determine a predicted value for each sensor and a corresponding fault state. As noted, the fault state for a given sensor may be used to indicate whether the integrated analysis tool 224 has determined that the given sensor may be experiencing a sensor fault. At step 320, the integrated analysis tool 224 evaluates the fault states, and tags the raw sensor data as being validated (in cases where the FPM tool 222 and the neural network tool 226 agree with the raw sensor values) or replaces the raw sensor data with the predicted value from the FPM tool 222 and the neural network tool 226 in cases where a sensor fault has been identified. The replacement value may be then used by plant control systems, e.g., in determining whether to trigger a plant trip event (shutting down the production plant) or used by other controllers configured to optimize plant operations.

Further, at step 325, the integrated analysis tool 224 may determine whether the predictions of the neural network tool 226 indicate that the neural network tool 226 needs to be retrained. For example, if the raw sensor data for one of the sensors agrees with the predicted value for that sensor determined by the FPM tool 222, but not with the value predicted by the neural network tool 226, then this may indicate that the neural network tool 226 needs to be trained using the current raw sensor data as a new training example. If retraining is indicated (the yes branch of step 325), then at step 330, the neural network is retrained using the validated and raw sensor data. Following the no branch of step 325 or step 330, method then returns to step 305 where the next period of sensor data is evaluated.

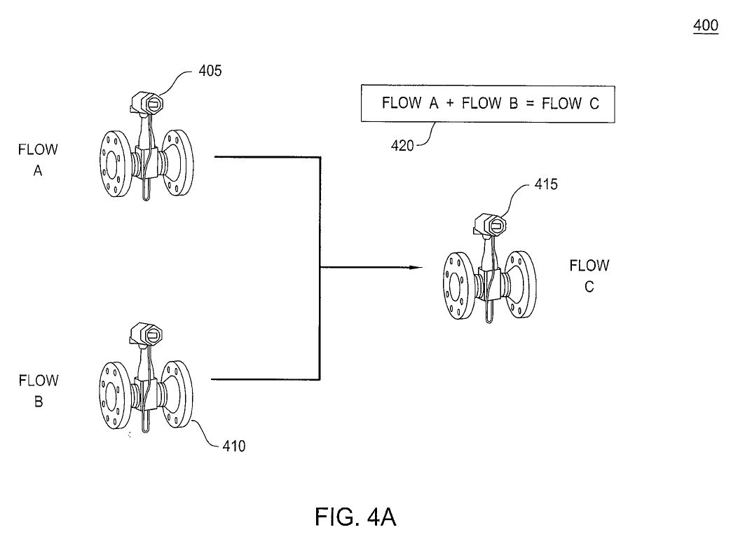

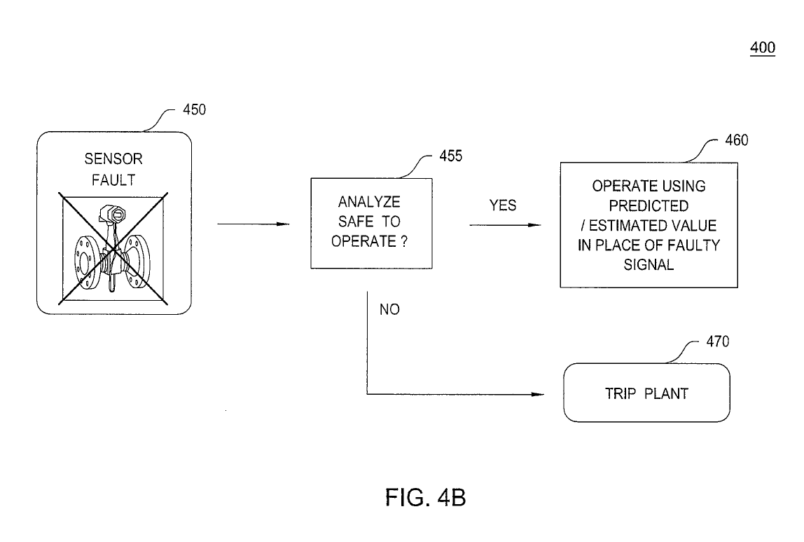

An example of the operations of method 300 is shown in FIGS. 4A-4B. More specifically, FIGS. 4A-4B illustrate an example of industrial sensors monitored using an integrated fault detection and analysis tool application to identify sensor faults, according to one embodiment of the invention. As shown, a first sensor 405 monitors a flow “A” and a second sensor 410 monitors a flow “B.” In this example, Flows “A” and “B” are combined where a third sensor 415 monitors the combined flow, as flow “C.” Thus, the flow at sensor “C” should be a function of the flows through at flow “A” and flow “B.” Further, given a sensor value for flow “A” from the first sensor 405 and a sensor value for flow “B” from the first sensor 410, the FPM tool 222 and the neural network tool 226 can predict what the third sensor 415 should report—shown in FIG. 4A as equation 420. Similarly, given a sensor value for flow “A” and a sensor value for flow “C,” the FPM tool 222 and the neural network tool 226 can predict what the second sensor 410 should report as flow “B”.

FIG. 4B illustrates an example of using the predicted values to determine whether a sensor fault has occurred, according to one embodiment of the invention. In this example, assume the integrated analysis tool 224 has determined that a sensor fault has been identified at sensor 450. That is, the sensor data reported by sensor 450 disagrees with the values predicted by the

FPM tool 222 and/or the neural network tool 224 (by more than a user-specified margin). In response, the integrated analysis tool 224 replaces the sensor data for sensor 450 with the predicted value. If the predicted value is within an acceptable operating range, then the controller systems operate using the predicted/estimated value in place of the faulty signal. However, if the predicted/estimated values indicate that the device monitored by sensor 450 is operating outside of the acceptable operating range, then a plant trip occurs at 470.

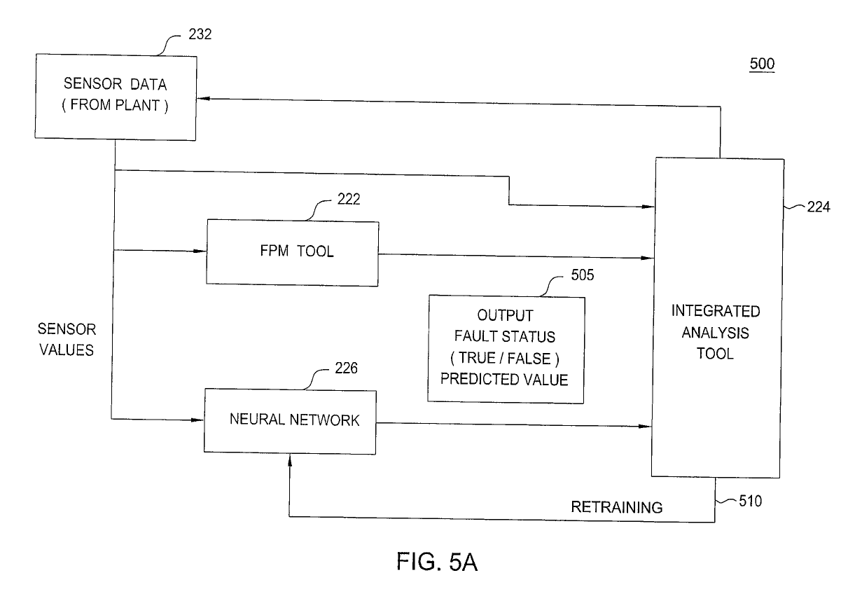

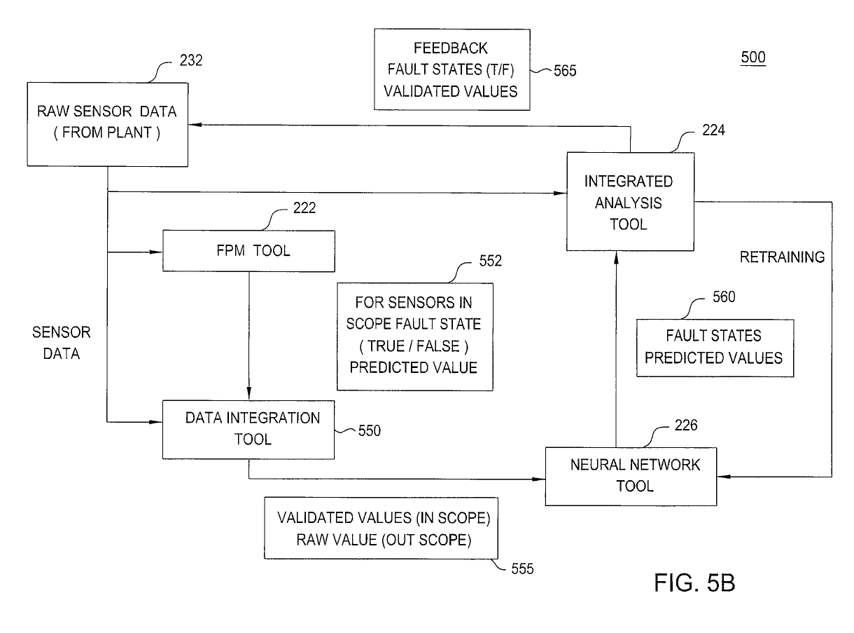

FIG. 5A-5B are data flow diagrams illustrating different approaches for an integrated fault detection and analysis tool application 224 to identify sensor faults, according to one embodiment of the invention. In particular, FIG. 5A illustrates an example where the FPM tool 222 and neural network tool 226 operate to validate sensor data in parallel to one another. In this example, the raw sensor data 232 is provided to both the FPM tool 222 and neural network tool 226 concurrently. Once received, the FPM tool 222 and neural network tool 226 generate a predicted value for each individual sensor, based on the values reported by other sensors. As shown, the output 505 provides a fault state of true/false and a predicted value for each sensor. The fault state for a given sensor indicates whether the FPM tool 222 and/or the neural network tool 226 have reported a sensor fault has occurred for that sensor. Once received, the integrated analysis tool 224 determines whether to replace any of the raw sensor data 232 with the predicted values or to tag some data values as being validated by the FPM tool 222 and/or neural network tool 226. Similarly, the integrated analysis tool 224 may determine whether to retrain the neural network tool 226 in cases where the FPM tool 222 has validated the raw sensor data for a given sensor, but the neural network tool 226 reported either a fault state (or a predicted value outside of a user-specified margin) for that sensor.

FIG. 5B illustrates an example where the FPM tool 222 and neural network tool 226 operate to validate sensor data sequentially, according to one embodiment of the invention. As shown, the raw sensor data 232 is first passed to the FPM tool 222, which, in response determines a predicted value 552 for each sensor within the scope of the FPM tool 222. That is, the FPM tool may provide a first principles model for some, but not all of the sensors at a production plant. The sensors validated by the FPM tool 222 are referred to as being validated. Accordingly, the FPM tool 222 reports a predicted value and a fault state for each sensor in-scope to the FPM tool 222.

In one embodiment, the results of from the FPM tool 222 are passed to the data integration tool 550. The data integration tool 550 interleaves the validated values from the FPM tool 222 and raw sensor data 232 and passes them to the neural network tool 226. Specifically, the in-scope validated values and any out- of-scope raw values (i.e., raw sensor data for sensors not modeled by the FPM tool 222) are combined and provided to the neural network tool 226. In some cases, the FPM tool 222 may not model a given sensor, but the neural network 226 might do so using the raw sensor data 232. Once received, the neural network tool 226 determines a fault state and a predicted value for each sensor and passes output 560 to the integrated analysis tool 224. As described above, the integrated analysis tool 224 may then provide feedback including the fault states and validated values 565 to the plant, where controllers can operate using the validated raw sensor data or the predicted/estimated values made by the FPM tool 222 and or the neural network tool 226. Further, in cases where the neural network tool 226 disagrees with the validated sensor data, the integrated analysis 224 tool may retrain the neural network using the validated sensor data.

### EXAMPLES

Table I, Table II, and Table III, below, summarize the different combinations of results for the sequential approach shown in FIG. 5B:

TABLE I
FPM Tool Fault State For Given Sensor = TRUE (Faulty Sensor)

```
Value fed to neural network tool: FPM prediction
Neural network fault state = False (Disagrees with FPM tool fault state)
  Integrated fault state = True
  Value fed back to process control sensors = FPM tool prediction
  Neural Network retraining Indication = True
Neural network fault state = True (Disagrees with FPM tool fault state)
  Integrated Fault State = True
  Value fed back to process control sensors = FPM tool prediction
  Neural Network retraining Indication = True
```

TABLE II
FPM Tool Fault State for Given Sensor = FALSE (validated sensor)

```
Value fed to neural network: Raw value (FPM tool Validated)
Neural network fault State = True (Disagrees with FPM tool fault state)
FPM tool and neural network predicted values agree
  Integrated fault state = True
  Neural Network retraining Indication = False
  Value fed back to process control sensors = Neural Network
  predicted value
Neural network fault state = False (agrees with FPM tool)
FPM tool and neural network predicted values disagree
  Integrated Fault State = False
  Neural Network retraining Indication = False
  Value to Feed Back to Process = Raw Value (Fully Validated)
```

TABLE III
FPM Tool Fault State for Given Sensor = No Indication

```
Value fed to neural network: Raw value
Neural network fault state = True
  Integrated fault state = True
  Neural network retraining Indication = False
  Value fed back to process control systems:
    If neural network retraining Indicator = True: Raw Value
    If neural network retraining Indicator = False: Neural network
    prediction
Neural Network fault state = False
  Integrated fault state = False
    Neural network retraining Indication = False
    Value fed back to system control process = Raw Value (Fully
    Validated)
```

Advantageously, embodiments of the invention provide techniques for sensor fault detection and analysis that help prevent plant trips caused by sensor faults (bad signals). When a sensor fault occurs, the underlying industrial process could be operating normally, but if the control system reacts to incorrect information provided by the sensor, the control system may cause the plant to shut down. As noted, such plant trips can be very expensive, as the plant is unnecessarily shut down until it is determined that the sensor (and not the plant) was the source of the plant trip. Accordingly, embodiments of the invention provide a fault detection and analysis tool that prevents unnecessary plant trips.

In one embodiment, a neural network based fault detection and analysis tool may be integrated with a physical (or semi-physical) modeling tool. For example, a first principles model (FPM) based fault detection and analysis tool may provide a mathematical model of plant processes, e.g., a set of mass/energy balance equations modeling the systems at a specific plant. In contrast, the neural network develops a model of a given set of sensors from the process data. One advantage of the neural network based tool is that it does not require fundamental knowledge of the process. However, the neural network is only valid for the conditions for which it was trained (i.e., conditions represented by a set of training data). Therefore, the neural network will occasionally need to be re-trained as the process conditions change. In contrast, the FPM first principles model based tool does not need to be retrained and remains valid for all process conditions accounted for in the fundamental models.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A computer-implemented method of for sensor fault detection and analysis, the method comprising:
receiving a sensor data value for each of one or more sensors, each monitoring an aspect of an industrial process;
passing at least some of the sensor data values to at least a physical modeling (PM) tool and a neural network modeling tool, wherein the PM tool and the neural network tool are each configured to determine a predicted value for each passed sensor data value;
determining, based on the sensor data values and the predicted values determined by the PM tool and the neural network tool, that at least one of the sensors has experienced a sensor fault; and
replacing the received sensor value for the sensor determined to have experienced the sensor fault with the predicted value determined by one of the PM tool and the neural network tool.

2. The method of claim 1, wherein the replaced sensor data value is passed to process control equipment configured to control an aspect of the industrial process.

3. The method of claim 1, further comprising:
upon determining the predicted value determined by the neural network tool differs from the predicted value determined by the PM tool by at least a specified amount, retraining the neural network tool.

4. The method of claim 1, wherein the sensor data values are passed to the PM tool and the neural network tool in parallel.

5. The method of claim 1, wherein the values are passed to the PM tool and the neural network tool sequentially, first to the PM tool and then to the neural network.

6. The method of claim 5, wherein the neural network tool predicts a value for at least one sensor value not passed to the PM tool.

7. The method of claim 1, further comprising,
validating, based on the sensor data values and the predicted values determined by the PM tool or the neural network tool, that at least one of the sensors has reported an accurate value.

8. The method of claim 7, wherein the validated sensor data values are passed to process control equipment configured to control an aspect of the industrial process.

9. A computer-readable storage medium containing a program, which, when executed on a processor, performs an operation for sensor fault detection and analysis, the operation comprising:
receiving a sensor data value for each of one or more sensors, each monitoring an aspect of an industrial process;
passing at least some of the sensor data values to at least a physical modeling (PM) tool and a neural network modeling tool, wherein the PM tool and the neural network tool are each configured to determine a predicted value for each passed sensor data value;
determining, based on the sensor data values and the predicted values determined by the PM tool and the neural network tool, that at least one of the sensors has experienced a sensor fault; and
replacing the received sensor value for the sensor determined to have experienced the sensor fault with the predicted value determined by one of the PM tool and the neural network tool.

10. The computer-readable storage medium of claim 9, wherein the replaced sensor data value is passed to process control equipment configured to control an aspect of the industrial process.

11. The computer-readable storage medium of claim 9, wherein the operation further comprises:
upon determining the predicted value determined by the neural network tool differs from the predicted value determined by the PM tool by at least a specified amount, retraining the neural network tool.

12. The computer-readable storage medium of claim 9, wherein the sensor data values are passed to the PM tool and the neural network tool in parallel.

13. The computer-readable storage medium of claim 9, wherein the values are passed to the PM tool and the neural network tool sequentially, first to the PM tool and then to the neural network.

14. The computer-readable storage medium of claim 13, wherein the neural network tool predicts a value for at least one sensor value not passed to the PM tool.

15. The computer-readable storage medium of claim 9, wherein the operation further comprises,
validating, based on the sensor data values and the predicted values determined by the PM tool or the neural network tool, that at least one of the sensors has reported an accurate value.

16. The computer-readable storage medium of claim 15, wherein the validated sensor data values are passed to process control equipment configured to control an aspect of the industrial process.

17. A system, comprising:
a processor; and
a memory storing a monitoring application, which, when executed by the processor, performs an operation for sensor fault detection and analysis, the operation comprising:
receiving a sensor data value for each of one or more sensors, each monitoring an aspect of an industrial process,
passing at least some of the sensor data values to at least a physical modeling (PM) tool and a neural network modeling tool, wherein the PM tool and the neural network tool are each configured to determine a predicted value for each passed sensor data value,
determining, based on the sensor data values and the predicted values determined by the PM tool and the neural network tool, that at least one of the sensors has experienced a sensor fault, and
replacing the received sensor value for the sensor determined to have experienced the sensor fault with the predicted value determined by one of the PM tool and the neural network tool.

18. The system of claim 17, wherein the replaced sensor data value is passed to process control equipment configured to control an aspect of the industrial process.

19. The system of claim 17, wherein the operation further comprises:
upon determining the predicted value determined by the neural network tool differs from the predicted value determined by the PM tool by at least a specified amount, retraining the neural network tool.

20. The system of claim 17, wherein the sensor data values are passed to the PM tool and the neural network tool in parallel.

21. The system of claim 17, wherein the values are passed to the PM tool and the neural network tool sequentially, first to the PM tool and then to the neural network.

22. The system of claim 21, wherein the neural network tool predicts a value for at least one sensor value not passed to the PM tool.

23. The system of claim 17, wherein the operation further comprises, validating, based on the sensor data values and the predicted values determined by the PM tool or the neural network tool, that at least one of the sensors has reported an accurate value.

24. The system of claim 23, wherein the validated sensor data values are passed to process control equipment configured to control an aspect of the industrial process.
